(19) United States
(12) Patent Application Publication
(10) Pub. No.: US 2017/0149590 A1
(43) Pub. Date: May 25, 2017

(54) METHOD AND SYSTEM FOR INVERSE CHIRP-Z TRANSFORMATION

(71) Applicant: KOREA AEROSPACE RESEARCH INSTITUTE, Daejeon (KR)

(72) Inventors: Dong Hyun KIM, Daejeon (KR); Dong Han LEE, Daejeon (KR)

(21) Appl. No.: 15/354,577

(22) Filed: Nov. 17, 2016

(30) Foreign Application Priority Data
Nov. 25, 2015 (KR) 10-2015-0165172

(51) Int. Cl. H04L 27/26

(52) U.S. Cl. CPC H04L 27/265

(57) ABSTRACT

Provided are a method and a system for an inverse chirp-z transformation, and more particularly, a method and a system for an inverse chirp-z transformation having improved availability as compared to conventional Inverse Discrete Fourier Transform (IDFT) or Inverse Fast Fourier Transform (IFFT) because a start time of an output signal and an interval between samples are freely adjustable in obtaining a signal on a time domain by performing an inverse transformation for any spectrum signal on a frequency domain.

### CROSS-REFERENCE TO RELATED APPLICATIONS

This application claims priority under 35 U.S.C. §119 to Korean Patent Application No. 10-2015-0165172, filed on Nov. 25, 2015, in the Korean Intellectual Property Office. The disclosure of which is incorporated herein by reference in its entirety for all purposes.

### TECHNICAL FIELD

The present invention relates to a method and a system for an inverse chirp-z transformation, and more particularly, to a method and a system for an inverse chirp-z transformation having improved availability as compared to conventional Inverse Discrete Fourier Transform (IDFT) or Inverse Fast Fourier Transform (IFFT) because a start time of an output signal and an interval between samples are freely adjustable in obtaining a signal on a time domain by performing an inverse transformation for any spectrum signal on a frequency domain.

### BACKGROUND

The Fourier Transform (FT) refers to transforming a function f(t) of a time domain which may be represented by an overlap of sine waves having different frequencies into a function F(t) of a frequency domain which represents amplitude of each frequency component included in f(t), and is widely used for fields such as signal analysis, image processing, control, and the like.

In particular, in a digital signal processing field using a computer, the Discrete Fourier transform (DFT) performing the FT by sampling a continuous signal over time at a constant interval, and the Fast Fourier transform (FFT) that significantly reduces operation times as compared to the DFT by using periodicity and symmetry of the signal are widely utilized.

Further, the DFT and the FFT refer to transforming the signal on the time domain into the spectrum signal on the frequency domain for the signal analysis. In contrast, there are also the Inverse DFT and Inverse FFT methods that inversely transform the signal on the frequency domain into the signal on the time domain.

The computer may not perform a continuous signal processing. Therefore, in order to address the signal using the computer, after the signal is processed into a finite discrete sampled signal by digitalizing (sampling) the signal, the DFT, FFT, CZT, IFFT, and the like are performed. That is, an actual input signal may be continuous and be infinite, but in the case of using the sampled signal on the time domain or the sampled spectrum signal on the frequency domain, the signal may be recovered to a signal which is maximally close to a continuous original signal.

As a form of this recovery, there is a chirp-z transformation (CZT) method, which is a technology of one forward transformation form, with a degree of freedom of a selection for a desired spectrum sample signal being infinitely extended. (See I. R. Rainer, Member, IEEE, R. W. Schafer, Member, IEEE, Bell Telephone Laboratories, Inc. “The Chirp z-Transform Algorithm”, June 1969 IEEE Transactions on Audio and Electroacoustics, pp. 86-92).

However, despite the advantages of the CZT as described above, availability of the CZT is lower than the DFT or FFT due to a limit that the Inverse CZT (ICZT) technology is not implemented even if the ICZT technology follows the methodology in the CZT technology as it is.

Therefore, as a complete counter technology substantially corresponding to the CZT technology, a method for implementing the ICZT is required.

### RELATED ART DOCUMENT

### Non-Patent Document

1. L. R. Rabiner, Member, IEEE, R. W. Schafer, Member, IEEE, Bell Telephone Laboratories, Inc. “The Chirp z-Transform Algorithm,” June 1969 IEEE Transactions on Audio and Electroacoustics, pp. 86-92.

2. L. I. Bluestein, Member IEEE, Electronic Systems Laboratory General Telephone and Electronics Laboratories, Inc., “A linear filtering approach to the computation of the discrete Fourier transform” December 1970 IEEE Transactions on Audio and Electroacoustics, pp. 451-455.

### SUMMARY

An embodiment of the present invention is directed to providing a method and a system for an inverse chirp-z transformation having a higher degree of freedom than a conventional IDFT or IFFT in a method for deriving a signal on a time domain by performing an inverse transformation for any spectrum signal on a frequency domain.

In one general aspect, a system for an inverse chirp-z transformation (ICZT) that inversely transforms any spectrum input signal on a frequency domain into a signal on a time domain includes: an input unit receiving any spectrum signal (X^{(z}_{is n}⁾) on the frequency domain; a setting unit setting a start time (t₀) of a final output signal (xₖ) and a time interval (Δt) between samples of the output signal (xₖ) and a calculating unit calculating the output signal (zₖ) on the time domain by reflecting actual frequency information (Fₙ) of a corresponding spectrum signal, and values (t_{g}, Δt) set by the setting unit to the spectrum signal (X^{(z}^{ₙ}⁾) input to the input unit and performing an Inverse Fast Fourier transform (IFFT) and a Fast Fourier transform (FFT).

The spectrum signal (X^{(z}^{ₙ}⁾) may be a discrete finite signal obtained by sampling a continuous signal at a constant frequency and performing a Discrete Fourier transform (DFT) or a Fast Fourier transform (FFT) or a Chirp-Z transform (CZT).

The output signal (zₖ) may be calculated by the following Equation:

$${x}_{k} = {W}^{\frac{{k}^{2}}{2}} \cdot [ FFT \{ IFFT \{ {Y}_{n} \} \cdot IFFT \{ {W}^{- \frac{{n}^{2}}{2}} \} \} ] , k = 0 , 1 , … , M - 1 \\ {Y}_{n} = X ( {z}_{n} ) \cdot {B}^{n} \cdot {W}^{\frac{{n}^{2}}{2}} , n = \frac{{F}_{n}}{Δ F} \\ B = {B}_{0} \cdot exp ( {j2πθ}_{0} ) , {θ}_{0} = Δ F \cdot {t}_{0} \\ W = {W}_{0} \cdot exp ( {j2πφ}_{0} ) , {φ}_{0} = Δ F \cdot Δ t . \qquad$$

(M is the number of output sample signals, ΔF is a frequency interval of an input spectrum signal, and B₀ and W₀ are amplitude constants).

In another general aspect, a method for an inverse chirp-z transformation (ICZT) that inversely transforms any spectrum input signal on a frequency domain into a signal on a time domain includes: a) receiving any spectrum signal (X^{(z}^{ₙ}⁾) on the frequency domain; b) setting a start time (t₀) of an output signal (zₖ) and a time interval (Δt) between samples of the output signal (xₖ); and c) calculating the output signal (xₖ) on the time domain by reflecting actual frequency information (Fₙ) of a corresponding spectrum signal, and values (t₀, Δt) set in the operation b) to the spectrum signal (X^{(z}^{ₙ}⁾) input in the operation a) and performing an Inverse Fast Fourier transform (IFFT) and a Fast Fourier transform (FFT).

### BRIEF DESCRIPTION OF THE DRAWINGS

FIG. 1 is a schematic configuration diagram of a system for an inverse chirp-z transformation according to an exemplary embodiment of the present invention.

FIGS. 2A, 2B, 3A, 3B, 4A, 4B, and 4C are verification examples of a method for an inverse chirp-z transformation according to an exemplary embodiment of the present invention.

### DETAILED DESCRIPTION OF MAIN ELEMENTS

10: input unit

20: setting unit

30: calculating unit

### DETAILED DESCRIPTION OF EMBODIMENTS

As described above, the CZT is a forward transformation method having a high degree of freedom in functionality as compared to the conventional DFT or FFT. However, since the ICZT, which is an inverse transformation of the CZT, is not derived even if a technology of implementing the CZT is conversely applied, a method for technologically implementing the ICZT was not conventionally suggested.

The present invention relates to a system and a method for an inverse chirp-z transformation (ICZT) that inversely transforms any spectrum input signal on a frequency domain into a signal on a time domain, and is intended to provide a method and a system which may be actually implemented from a technical form of the ICZT based on a conventional CZT technology.

Hereinafter, a technical spirit of the present invention will be described in more detail with reference to the accompanying drawings.

The accompanying drawings are only examples shown in order to describe the technical spirit of the present invention in more detail. Therefore, the technical spirit of the present invention is not limited to shapes of the accompanying drawings.

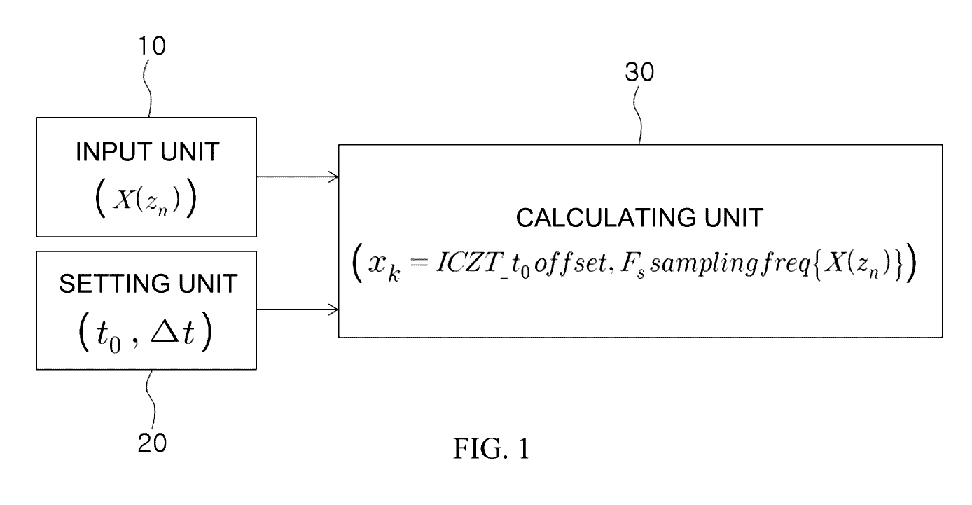

FIG. 1 is a schematic configuration diagram of a system for an inverse chirp-z transformation according to an exemplary embodiment of the present invention. As shown, the system for an inverse chirp-z transformation according to the present invention may be configured to include an input unit 10, a setting unit 20, and a calculating unit 30.

The input unit 10 serves to receive any spectrum signal (X^{(z}^{ₙ}⁾) on a frequency domain. In this case, the spectrum signal (X^{(z}^{ₙ}⁾) input to the input unit 10 may be a discrete finite signal obtained by sampling a continuous signal at a constant frequency and performing a Discrete Fourier transform (DFT) or a Fast Fourier transform (FFT) or a Chirp-Z transform (CZT).

In addition, the setting unit 20 sets a start time (t₀) of a signal (zₖ) to be finally output from the calculating unit 30 and a time interval (Δt) between samples of the output signal (zₖ). In this case, the set values (t₀, Δt) may be changed as much as a user wants.

Finally, the calculating unit 30 calculates the output signal (xₖ) on the time domain by reflecting actual frequency information (Fₙ) of a corresponding spectrum signal (X^{(z}^{ₙ}⁾) and the values (t₀, Δt) set by the setting unit 20 to the spectrum signal (X^{(z}^{ₙ}⁾) input from the input unit 10 and then performing an Inverse Fast Fourier transform (IFFT) and FFT. In this case, on the drawing, Fₛ means

$$\frac{1}{Δ t} .$$

Specifically, the output signal (xₖ) calculated by the calculating unit 30 is implemented by the following Equation 1.

$${x}_{k} = {W}^{\frac{{k}^{2}}{2}} \cdot [ FFT \{ IFFT \{ {Y}_{n} \} \cdot IFFT \{ {W}^{- \frac{{n}^{2}}{2}} \} \} ] , \\ k = 0 , 1 , … , M - 1 \\ {Y}_{n} = X ( {z}_{n} ) \cdot {B}^{n} \cdot {W}^{\frac{{n}^{2}}{2}} n = \frac{{F}_{n}}{Δ F} \\ B = {B}_{0} \cdot exp ( {j2πθ}_{0} ) , {θ}_{0} = Δ F \cdot {t}_{0} \\ W = {W}_{0} \cdot exp ( {j2πφ}_{0} ) , {φ}_{0} = Δ F \cdot Δ t \qquad [ Equation 1 ]$$

(Here, M is the number of output sample signals, ΔF is a frequency interval of an input spectrum signal, and B₀ and W₀, which are amplitude constants, are set to 1 to increase speed and accuracy of a signal processing).

As such, since the output signal (xₖ) may be easily implemented by a combination of IFFT and FFT, and values of a variable (B) adjusting a time at which the sample signal (xₖ) to be output from the calculating unit 30 starts and a variable (W) adjusting a time interval in which the sample signal (xₖ) is formed are determined by the values (t₀, Δt) set by the setting unit 20, the sample signal (xₖ) having a high degree of freedom of a selection may be obtained.

Hereinafter, a process of deriving an implementation form of the output signal (xₖ) of the calculating unit expressed by the above Equation 1 will be proved.

A technology form of the conventional CZT may be expressed as in the following Equation 2 such as being suggested in the Related Art Document 1.

$${X}_{k} = {\sum }_{n = 0}^{N - 1} {x}_{n} \cdot {B}^{- n} \cdot {W}^{nk} , k = 0 , 1 , … , M - 1 \qquad [ Equation 2 ]$$

A technical form of the ICZT, which is a converse concept of the CZT, is expressed by the following Equation 3.

$${x}_{k} = {\sum }_{n = 0}^{N - 1} X ( {z}_{n} ) \cdot {B}^{n} \cdot {W}^{nk} , k = 0 , 1 , … , M - 1 \qquad [ Equation 3 ]$$

In this case, according to a principle suggested in the related art document 2, Equation 3 is developed by substituting n·k in a phase component of W^{nk} of Equation 3 as follows.

$$\begin{matrix}n \cdot k = \frac{{n}^{2} + {k}^{2} - {( k - n )}^{2}}{2} & [ Equation 4 ] \\ {x}_{k} = {W}^{\frac{{k}^{2}}{2}} \cdot {\sum }_{n = 0}^{N - 1} [ X ( {z}_{n} ) \cdot {B}^{n} \cdot {W}^{\frac{{n}^{2}}{2}} \cdot {W}^{\frac{- {( k - n )}^{2}}{2}} ] , \\ k = 0 , 1 , … , M - 1 & [ Equation 5 ]\end{matrix}$$

The above Equation 5 may be summarized in a convolution (*) form as follows.

$${x}_{k} = {W}^{\frac{{k}^{2}}{2}} \cdot ( {Y}_{n} * {W}^{- \frac{{n}^{2}}{2}} ) , k = 0 , 1 , … , M - 1 \\ {Y}_{n} = X ( {z}_{n} ) \cdot {B}^{n} \cdot {W}^{\frac{{n}^{2}}{2}} . \qquad [ Equation 6 ]$$

Considering that the convolution (*) on the time domain is a product on the frequency domain, the convolution may be simply implemented by performing the IFFT for each of the two signals, multiplying the two signals, and then again performing the FFT. According to the conventional CZT, the FFT is performed for each of the two signals, the two signals are multiplied, and then the IFFT is performed, but according to the present invention, since input data is the spectrum signal on the frequency domain, the implementation of the convolution is inversely performed.

Therefore, the convolution (*) of the above Equation 6 is expressed by a combination of FFT and IFFT as in Equation 7.

$$( {Y}_{n} * {W}^{- \frac{{n}^{2}}{2}} ) = FFT \{ IFFT \{ {Y}_{n} \} \cdot IFFT \{ {W}^{- \frac{{n}^{2}}{2}} \} \} \qquad [ Equation 7 ]$$

As such, by substituting the derived Equation 7 into Equation 6, the above Equation 1, which is the final implementation form of the ICZT, may be derived.

At the time of implementing the ICZT according to the present invention, a variable n is defined as an actual frequency sample number of the input spectrum signal. That is, as expressed in Equation 1, n is a value obtained by dividing the actual frequency information (Fₙ) of the input spectrum sample signal by a frequency interval (ΔF) of the input spectrum signal.

As such, according to the present invention, since the actual frequency sample number (n) needs to be applied, the actual frequency information (Fₙ) on the spectrum signal input to the input unit 10 needs to be used, and this information is information which is known before performing the DFT, FFT, or CZT, which is a prior operation of the ICZT, in planning the signal processing.

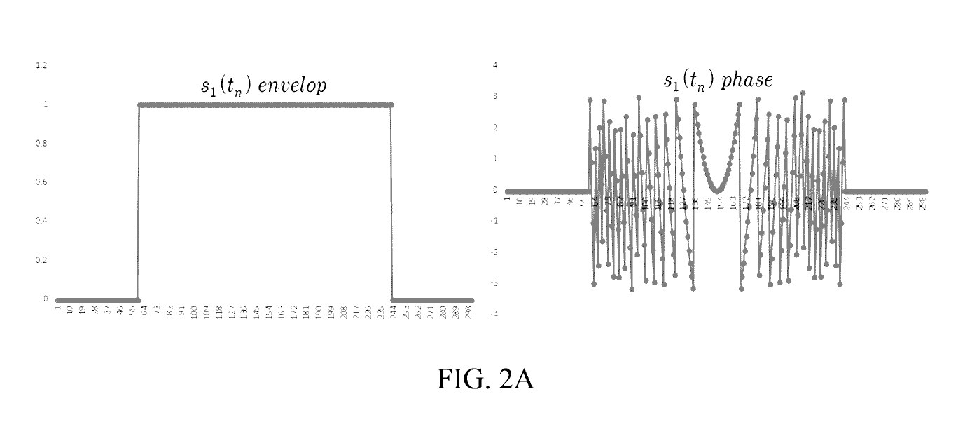

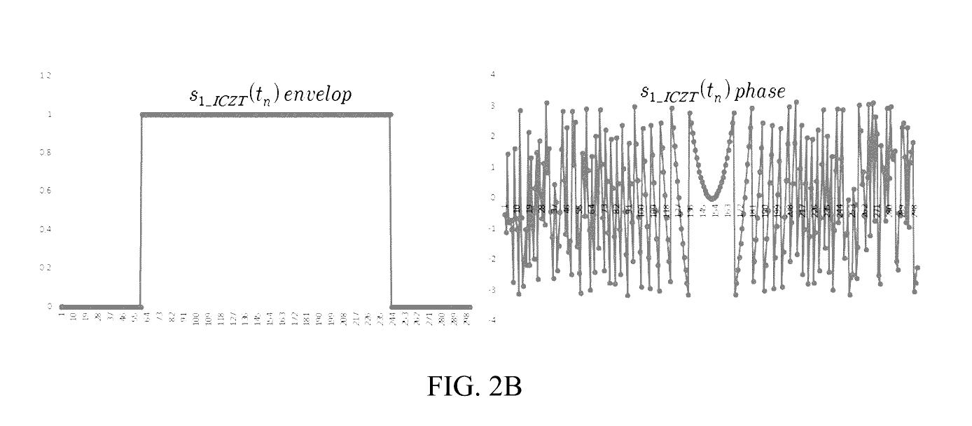

Hereinabove, the process of deriving the implementation form of the ICZT according to the present invention was described. Hereinafter, a result obtained by verifying accuracy of the implementation form of the ICZT will be described with reference to FIGS. 2 to 4.

All verifications were performed based on any continuous time signal (s₀(t)), and a verification method compares magnitude of the signal with a result obtained by performing the ICZT according to the present invention using actual reference data for phase information.

A first verification compares s₁(tₙ) with a result obtained by performing ICZT{FFT{s₁(tₙ)}}. That is, a spectrum signal S₁(fₖ) is obtained by performing the FFT for

$${s}_{0} ( \frac{n}{{F}_{1}} ) = {s}_{1} ( {t}_{n} ) ,$$

which is a signal obtained by sampling s₀(t) at a sampling frequency F₁, and s₁_{_}_{ICZT}(tₙ), which is a result obtained by regenerating s₁(tₙ) by performing the ICZT using S₁(fₖ) as an input, is confirmed.

FIG. 2A is a graph illustrating an envelope and a phase for a signal

$${s}_{1} ( {t}_{n} ) = {s}_{0} ( \frac{n}{{F}_{1}} ) ,$$

and FIG. 2B illustrates a result graph obtained by regenerating s₁(tₙ) by performing ICZT{FFT{s₁(tₙ)}}.

That is, comparing FIGS. 2A and 2B, it may be confirmed that two signals are very similar to each other within a section in which s₁(tₙ), which is the reference signal, exists.

A second verification verifies a time offset and a time interval adjustment function between samples of the ICZT.

In the same way as the first verification described above, the spectrum signal S₁(fₖ) is obtained by performing the FFT for

$${s}_{0} ( \frac{n}{{F}_{1}} ) = {s}_{1} ( {t}_{n} ) ,$$

which is the signal obtained by sampling s₀(t) at the sampling frequency F₁, the ICZT is performed using S₁(fₖ) as an input, and s₂_{_}_{ICZT}(tₙ) is obtained by applying a time offset t₀ and a new sample frequency

$${F}_{2} \frac{1}{( Δ t )}$$

to a final output result signal. This is compared with

$${s}_{2} ( {t}_{n} ) = {s}_{0} ( {t}_{0} + \frac{n}{{F}_{2}} ) ,$$

which is an actual reference signal.

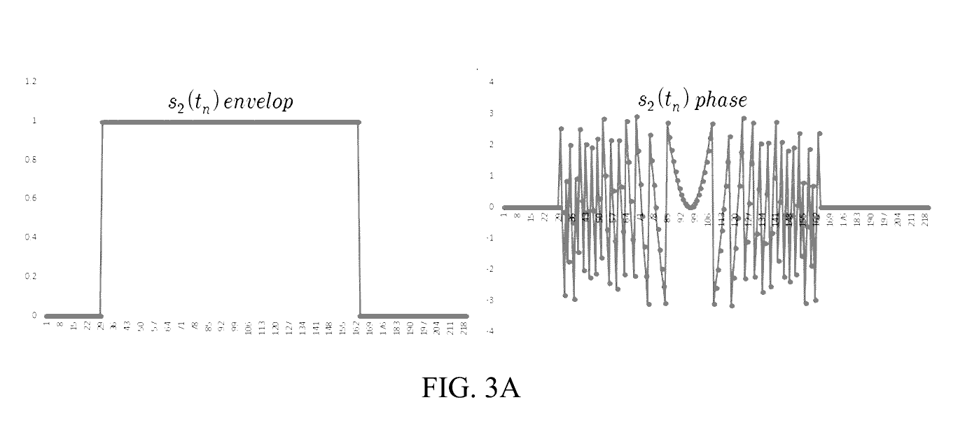

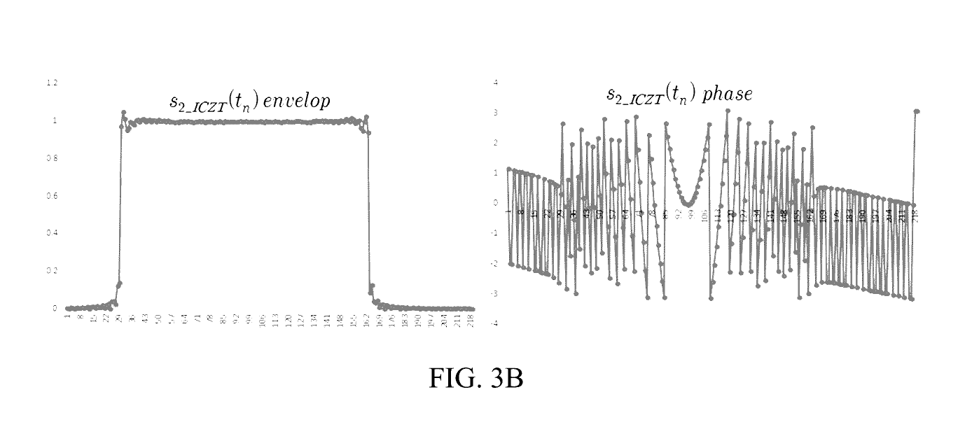

FIG. 3A shows a graph illustrating an envelope and a phase of

$${s}_{2} ( {t}_{n} ) = {s}_{0} ( {t}_{0} + \frac{n}{{F}_{2}} ) ,$$

which is the reference signal, and FIG. 3B shows a result graph obtained by regenerating s₂(tₙ) by performing ICZT_t₀ offset, F₂ samplingfrequency{FFT{s₁(tₙ)}}.

Also in this case, comparing FIGS. 3A and 3B, it may be confirmed that two signals are very similar to each other within a section in which s₂(tₙ), which is the reference signal, exists. Therefore, the time offset and the sampling frequency adjustment function of the ICZT were verified.

A final verification verifies a basic function when the ICZT is performed using CZT result data corresponding to limited spectrum data as an input, and verifies the time offset and the time interval adjustment function between the samples.

That is, the spectrum signal s₁_{_}_{CZT}(fₖ) is obtained by performing the CZT for

$${s}_{0} ( \frac{n}{{F}_{1}} ) = {s}_{1} ( {t}_{n} ) ,$$

which is the signal obtained by sampling s₀(t) at the sampling frequency F₁. The ICZT is performed using S₁_{_}_{CZT}(fₖ) as the input, and s₃_{_}_{ICZT}(tₙ) is obtained by applying the time offset t₀ and a new sampling frequency F₂ to the final output result signal. This is compared with

$${s}_{2} ( {t}_{n} ) = {s}_{0} ( {t}_{0} + \frac{n}{{F}_{2}} ) ,$$

which is the actual reference signal.

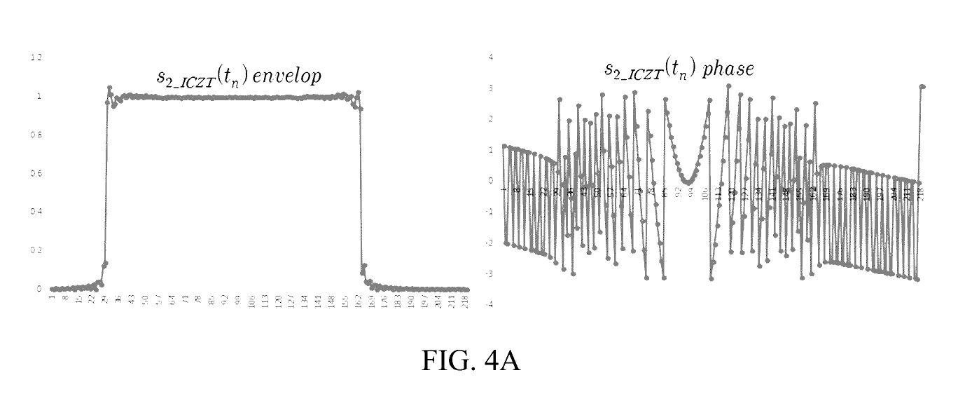

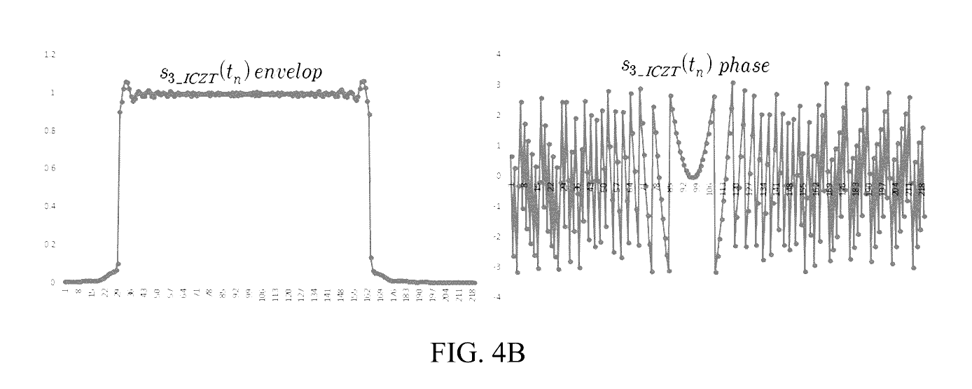

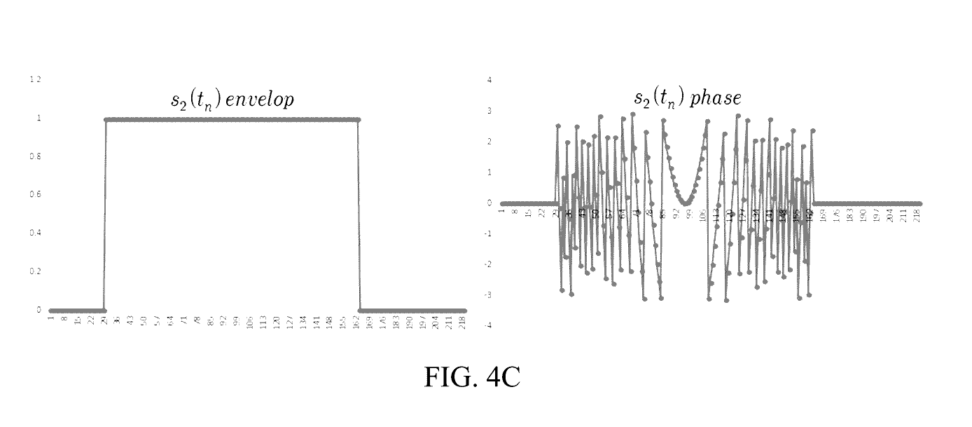

FIG. 4A illustrates an envelope and a phase of a signal S₁_{_}_{CZT}(fₖ)=CZT{s₁(tₙ)}, FIG. 4B is a result graph obtained by regenerating s₃(tₙ) by performing ICZT_t₀offset, F₂samplingfrequency{CZT{s₁(tₙ)}}, and FIG. 4C is a graph illustrating an envelope and a phase of

$${s}_{3} ( {t}_{n} ) = {s}_{0} ( {t}_{0} + \frac{n}{{F}_{2}} ) ,$$

which is a reference signal to be compared with the graph of FIG. 4B.

Similarly in this case, it was confirmed that two signals (FIGS. 4C and 4B) are very similar to each other within a section in which the reference signal exists, and a basic inverse transformation function, the time offset, and the sample frequency adjustment function of ICZT/CZT were verified.

In summary, according to the present invention, the method and the system capable of implementing the ICZT as a complete implementation form corresponding to the CZT may be provided. In particular, according to the present invention, since the time at which the final output signal on the time domain starts and the interval between the samples may be freely adjusted by arbitrarily setting the setting values (t₀, Δt), the degree of freedom may be very high at the time of forming the signal.

The conventional IDFT or IFFT may obtain the inversely transformed result only by the defined start time and the time interval between the samples, and needs to apply a circuitous technology such as additional interpolation, or the like to obtain the desired signal, but according to the present invention, since the above-mentioned processes are unnecessary, it is possible to solve complexity and a difficulty in the implementation.

The present invention is not limited to the above-mentioned exemplary embodiments, and may be variously applied, and may be variously modified without departing from the gist of the present invention claimed in the claims.

What is claimed is:

1. A system for an inverse chirp-z transformation (ICZT) that inversely transforms any spectrum input signal on a frequency domain into a signal on a time domain, the system comprising:
an input unit receiving any spectrum signal (X^{(z}^{ₙ}⁾) on the frequency domain;
a setting unit setting a start time (t₀) of a final output signal (zₖ) and a time interval (Δt) between samples of the output signal (zₖ); and
a calculating unit calculating the output signal (xₖ) on the time domain by reflecting actual frequency information (Fₙ) of a corresponding spectrum signal, and values (t₀, Δt) set by the setting unit to the spectrum signal (X^{(z}^{ₙ}⁾) input to the input unit and performing an Inverse Fast Fourier transform (IFFT) and a Fast Fourier transform (FFT).

2. The system for an ICZT of claim 1, wherein the spectrum signal (X^{(z}^{ₙ}⁾) is a discrete finite signal obtained by sampling a continuous signal at a constant frequency and performing a Discrete Fourier transform (DFT) or a Fast Fourier transform (FFT) or a Chirp-Z transform (CZT).

3. The system for an ICZT of claim 1, wherein the output signal (zₖ) is calculated by the following Equation:
$${x}_{k} = {W}^{\frac{{k}^{2}}{2}} \cdot [ FFT \{ IFFT \{ {Y}_{n} \} \cdot IFFT \{ {W}^{- \frac{{n}^{2}}{2}} \} \} ] , k = 0 , 1 , … , M - 1$$
$${Y}_{n} = X ( {z}_{n} ) \cdot {B}^{n} \cdot {W}^{\frac{{n}^{2}}{2}} , n = \frac{{F}_{n}}{Δ F}$$
$$B = {B}_{0} \cdot exp ( j 2 {πθ}_{0} ) , {θ}_{0} = Δ F \cdot {t}_{0}$$
$$W = {W}_{0} \cdot exp ( {j2πφ}_{0} ) , {φ}_{0} = Δ F \cdot Δ t .$$
(M is the number of output sample signals, ΔF is a frequency interval of an input spectrum signal, and B₀ and W₀ are amplitude constants).

4. A method for an inverse chirp-z transformation (ICZT) that inversely transforms any spectrum input signal on a frequency domain into a signal on a time domain, the method comprising:
a) receiving any spectrum signal (X^{(z}^{ₙ}⁾) on the frequency domain;
b) setting a start time (t₀) of an output signal (xₖ) and a time interval (Δt) between samples of the output signal (xₖ); and
c) calculating the output signal (xₖ) on the time domain by reflecting actual frequency information (Fₙ) of a corresponding spectrum signal, and values (t₀, Δt) set in the operation b) to the spectrum signal (X^{(z}^{ₙ}⁾) input in the operation a) and performing an Inverse Fast Fourier transform (IFFT) and a Fast Fourier transform (FFT).
